(19) United States
(12) Patent Application Publication
(10) Pub. No.: US 2020/0074543 A1
(43) Pub. Date: Mar. 5, 2020

(54) A SYSTEM FOR PROVIDING A DISTRIBUTED NETWORK TO VALIDATE TRANSACTIONS FOR FINANCING

(71) Applicant: HARNEK CHANDI, VANCOUVER (CA)

(72) Inventor: HARNEK CHANDI, VANCOUVER (CA)

(21) Appl. No.: 16/559,947

(22) Filed: Sep. 4, 2019

Related U.S. Application Data
(60) Provisional application No. 62/726,601, filed on Sep. 4, 2018.

(51) Int. Cl. G06Q 40/02; G06Q 20/36; G06Q 30/04; G06F 16/23

(52) U.S. Cl. CPC G06Q 40/025; G06F 16/2315; G06Q 30/04; G06Q 20/3672

(57) ABSTRACT

A system for providing a distributed network to validate transaction between at least two parties for financing is having a blockchain service database for storing information relating to transactions and plurality of modules; a processor coupled to the blockchain service database for processing the plurality of modules; and a display unit to display the processed plurality of modules. The plurality of modules includes a registration module, a job module, a financing module, a risk assessment module, a token module, and a credit module.

### CORRESPONDING TO RELATED APPLICATION

This present application claims priority to and the benefit of U.S. Provisional Patent Application No. 62/726,601, entitled “A system for providing a distributed network to validate transactions for financing,” filed Sep. 4, 2018, which is hereby incorporated by reference in its entirety.

### BACKGROUND OF THE INVENTION

### 1. Field of the Invention

The present invention generally relates to a system for managing transactions, and more particularly related to a system for providing a distributed network to validate transaction for financing.

### 2. Description of Related Art

Invoice financing is a way for businesses to borrow money against the amounts due from customers. Invoice financing helps businesses improve cash flow, pay employees and suppliers, and reinvest in operations and growth earlier than they could if they had to wait until their customers paid their balances in full. Businesses pay a percentage of the invoice amount to the lender as a fee for borrowing the money. In computerized transactions, a seller often sends goods to a customer before getting paid for such goods. The seller might wait for a significant period of time before receiving payment for the goods. For instance, the seller might have to wait for 30 days, 60 days, 90 days, 120 days, etc., for receiving payments from the customer depending on terms of the transaction.

In the meantime, the seller may have significant capital locked up in the goods. For example, the seller may have had to spend $1 million for the raw materials and labour to produce the goods. Until the seller receives payment, this capital is tied up and cannot be used for other operations, such as producing new goods. Thus in such cases invoice financing comes handy. A credit score is a value that represents the creditworthiness of a person, business, organization or other entity. A credit score is calculated based on credit report information typically sourced from credit bureaus. Over the life of an individual there may be different events that can be relevant (directly or indirectly) to the creditworthiness of a person, business, organization or other entity.

Creditors or lenders use credit scores to evaluate the potential risk posed by lending money to a borrower. Lenders use credit scores to determine whether a borrower qualifies for a loan, at what interest rate, and what credit limits. Credit scoring is often conducted prior to authorizing access or granting credit. Thus, creditors or lenders require risk assessment of the companies/people party in the invoice financing. Conventional loan processing services have several disadvantages including, but not limited to, high transaction fees and volatility tied to centralized currency systems. Therefore, there is a need of a system for providing a decentralized network to validate transactions for invoice financing. Further, the system should be able perform risk assessment for invoice financing.

### SUMMARY OF THE INVENTION

In accordance with teachings of the present invention, a system for providing a distributed network to validate transaction for invoice financing is disclosed.

An object of the present invention is to provide a system including a blockchain service database for storing information relating to transactions and plurality of modules; a processor coupled to the blockchain service database for processing the plurality of modules; and a display unit to display the processed plurality of modules.

The plurality of modules includes a registration module to allow registration of consortium members and end users; a job module to allow the end users to exchange job on the blockchain service database, wherein the job is at least one of a product; and a service; a financing module for allowing an end user to raise request for financing; a risk assessment module for conducting risk assessment on the parties associated with the financing, further the risk assessment module conduct risk assessment on the basis of accounting data, banking data and related factors, furthermore the risk assessment module computes a risk score based on the accounting data, the banking data and related factors extracted from the blockchain service database; a token module creates tokens which reflects digital currency; and a credit module to issue tokens to the end user seeking financing based upon their risk score, further the credit module facilitates and track the tokens movement among end users.

### BRIEF DESCRIPTION OF DRAWINGS

FIG. 1 illustrates a block diagram of a system for providing a distributed network to validate transaction for invoice financing in accordance with a preferred embodiment of the present invention.

### DETAILED DESCRIPTION OF DRAWINGS

While this technology is illustrated and described in a preferred embodiment, a system for providing a distributed network to validate transaction for business payments be produced in many different configurations, and computer languages. This is depicted in the drawings and will be described in detail, as a preferred embodiment of the invention, with the understanding that the present disclosure is to be considered as an exemplification of the principles of the invention and the associated functional specifications for its construction. It is not intended to limit the invention to the embodiment illustrated. Those skilled in the art will envision many other possible variations within the scope of the technology described herein.

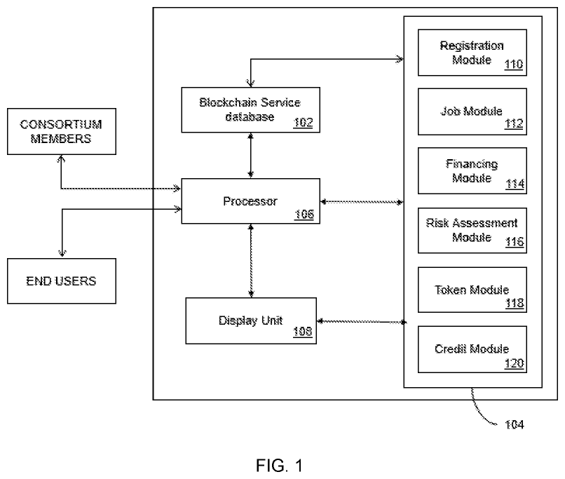

FIG. 1 illustrates a block diagram of a system 100 for providing a distributed network to validate transaction for business payments in accordance with a preferred embodiment of the present invention. The system 100 further includes a blockchain service database 102, plurality of modules 104, a processor 106 and a display unit 108.

The blockchain service database 102 stores information related to transactions and plurality of modules 104. The blockchain service database 102 allows each participant to maintain, calculate and update new entries into the database. All nodes work together to ensure they are all coming to the same conclusions, providing in-built security for the distributed network.

The processor 106 is coupled to the blockchain service database 102 for processing the plurality of modules 104. Examples of the processor 106 includes but not limited to microcontroller, microprocessor, a smart computer and other similar computing devices.

The display unit 108 displays the processed plurality of modules 104. Examples of the display unit 108 includes but not limited to LED, LCD, HD, OLED and other similar display screens of a computing device etc. The plurality of modules 104 includes a registration module 110, a job module 112, a financing module 114, a risk assessment module 116, a token module 118 and a credit module 120.

The registration module 110 allows registration of consortium members and end users. Examples of the consortium members include but not limited to QuickBooks Online, Xero, Zoho Books, FreshBooks, SAP, Walmart, Verizon, banks, tax authorities etc. Examples of the end users include but not limited to companies, associates of companies, proprietors, partnership firms, vendors, customers, accountants etc.

The job module 112 allows the end users to exchange job on the blockchain service database. The job may either be a selling of a product or selling of a service or any other business transaction between two or more end users. In a preferred embodiment the business transactions between the two end users are settled directly between them.

The financing module 114 allowing an end user to raise request for financing. In a preferred embodiment of the present invention, the request for financing is based upon on invoice financing. However, it would be readily apparent to those skilled in the art that the request for financing may be raised for various other purposes too without deviating from the scope of the present invention.

The risk assessment module 116 conducts risk assessment on the parties associated with the financing. Further the risk assessment module 116 conducts risk assessment on the basis of accounting data, banking data and related factors. Furthermore, the risk assessment module computes a risk score based on the accounting data, the banking data and related factors extracted from the blockchain service database.

Examples of the accounting data include but not limited to information and data contained in journals, ledgers and other records approved by end users and available to the consortium members. Examples of the banking data includes but not limited to account balance, cash flow, deposits, withdrawals etc.

The token module 118 creates tokens which reflects digital currency. The credit module 120 issue tokens to the end user seeking financing based upon their risk score. Further, the credit module 120 facilitates and track the tokens movement among end users.

For exemplary purposes, a company A sells product to another company B and the transaction is stored in the blockchain service database. Company A raises invoice to Company B. Company A seeks invoice financing from the system. The system calculates risk score of giving financing to Company A based upon various factors such as accounting, banking and other related data processed in the blockchain service database. The system generates token based upon the calculated risk score.

Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

1. A system for providing a distributed network to validate transaction between at least two parties for financing, the system comprising:
a blockchain service database for storing information relating to transactions and plurality of modules;
a processor coupled to the blockchain service database for processing the plurality of modules; and
a display unit to display the processed plurality of modules;
the plurality of modules comprising:
a registration module to allow registration of consortium members and end users;
a job module to allow the end users to exchange job on the blockchain service database, wherein the job is at least one of a product; and a service;
a financing module for allowing an end user to raise request for financing;
a risk assessment module for conducting risk assessment on the parties associated with the financing, further the risk assessment module conduct risk assessment on the basis of accounting data, banking data and related factors, furthermore the risk assessment module computes a risk score based on the accounting data, the banking data and related factors extracted from the blockchain service database;
a token module creates tokens which reflects digital currency; and
a credit module to issue tokens to the end user seeking financing based upon their risk score, further the credit module facilitates and track the tokens movement among end users.
